(19) United States
(12) Patent Application Publication
(10) Pub. No.: US 2026/0309657 A1
(43) Pub. Date: Oct. 8, 2026

(54) TIRE FAILURE DETERMINATION METHOD AND TIRE FAILURE DETERMINATION APPARATUS

(71) Applicant: BRIDGESTONE CORPORATION, Tokyo (JP)

(72) Inventor: Shu KONDO, Chuo-ku, Tokyo (JP)

(73) Assignee: BRIDGESTONE CORPORATION, Tokyo (JP)

(21) Appl. No.: 19/484,608

(22) PCT Filed: Nov. 28, 2023
(86) PCT No.: PCT/JP2023/042591

§ 371 Date: Nov. 14, 2025

(30) Foreign Application Priority Data
May 31, 2023 (JP) 2023-090193

(51) Int. Cl. G01N 25/72; G01J 5/48

(52) U.S. Cl. CPC G01N 25/72; G01J 5/48

(57) ABSTRACT

A tire failure determination method according to the present disclosure is a tire failure determination method to be executed by a computer and includes acquiring a thermal image obtained by imaging a tire with a thermographic camera, acquiring an inner cavity temperature of the tire, and estimating a depth of a damaged portion of the tire based on a surface temperature of the damaged portion in the thermal image and the inner cavity temperature at a time when the thermal image was captured.

### TECHNICAL FIELD

The present disclosure relates to a tire failure determination method and a tire failure determination apparatus.

### BACKGROUND

Techniques for determining tire failure are known. For example, PTL 1 discloses a tire damage detection system that detects the size of a damaged portion of a tire based on the diameter of a rim wheel, using image data of a tire assembled to the rim wheel.

### CITATION LIST

### Patent Literature

PTL 1: JP 2019-202729 A

### SUMMARY

### Technical Problem

However, there is a demand for further improvement in the usefulness of techniques for determining tire failure. For example, in mining vehicles used at mine sites, if a sudden tire failure occurs, productivity decreases due to the occurrence of operations such as transportation by the mining vehicle and tire replacement. In addition, periodic tire inspections by workers to prevent sudden failures impose a cost burden. Therefore, automation of tire failure determination is required.

In view of these circumstances, an object of the present disclosure is to provide a tire failure determination method and a tire failure determination apparatus that improve the usefulness of techniques for determining tire failure.

### Solution to Problem

[1] A tire failure determination method according to one embodiment of the present disclosure is a tire failure determination method executed by a computer, comprising: acquiring a thermal image obtained by imaging a tire with a thermographic camera; acquiring an inner cavity temperature of the tire; and estimating a depth of a damaged portion of the tire based on a surface temperature of the damaged portion in the thermal image and the inner cavity temperature at a time when the thermal image was captured.
[2] The tire failure determination method according to one embodiment of the present disclosure is the tire failure determination method described in [1], further comprising detecting, as the damaged portion, a portion on an outer surface of the tire appearing in the thermal image, the portion being higher than surrounding portions by a threshold temperature or more, and it is preferable that the threshold temperature is changed according to the inner cavity temperature at the time when the thermal image was captured.
[3] The tire failure determination method according to one embodiment of the present disclosure is the tire failure determination method described in [1] or [2], wherein the estimating of the depth of the damaged portion preferably includes correcting the depth of the damaged portion according to the inner cavity temperature at the time when the thermal image was captured.
[4] The tire failure determination method according to one embodiment of the present disclosure is the tire failure determination method described in [3], wherein the estimating of the depth of the damaged portion preferably includes correcting the depth of the damaged portion so that a correction amount of the depth of the damaged portion increases as the inner cavity temperature at the time when the thermal image was captured is higher.
[5] The tire failure determination method according to one embodiment of the present disclosure is the tire failure determination method described in any one of [1] to [4], wherein the estimating of the depth of the damaged portion preferably includes correcting the depth of the damaged portion according to a position of the damaged portion in the tire.

[6] The tire failure determination method according to one embodiment of the present disclosure is the tire failure determination method described in any one of [1] to [5], further comprising determining whether the depth of the damaged portion is within an allowable range of durability of the tire.
[7] The tire failure determination method according to one embodiment of the present disclosure is the tire failure determination method described in [6], wherein the determining preferably includes, in a case in which a plurality of damaged portions is detected in the tire, determining whether depths of the plurality of damaged portions are within the allowable range based on relative depths of the plurality of damaged portions.
[8] The tire failure determination method according to one embodiment of the present disclosure is the tire failure determination method described in [6] or [7], further comprising acquiring a travel distance or travel time of a vehicle on which the tire is mounted, and the determining includes determining whether the depth of the damaged portion is within the allowable range based on the depth of the damaged portion and the travel distance or travel time of the vehicle, and it is preferable that the allowable range is set so that the depth of the damaged portion is more likely to fall outside the allowable range as the depth of the damaged portion is deeper and the travel distance or travel time of the vehicle is shorter.
[9] A tire failure determination apparatus according to one embodiment of the present disclosure comprises a controller configured to acquire a thermal image obtained by imaging a tire with a thermographic camera, acquire an inner cavity temperature of the tire, and estimate a depth of a damaged portion of the tire based on a surface temperature of the damaged portion in the thermal image and the inner cavity temperature at a time when the thermal image was captured.

### Advantageous Effect

According to the present disclosure, it is possible to provide a tire failure determination method and a tire failure determination apparatus that can improve the usefulness of techniques for determining tire failure.

### BRIEF DESCRIPTION OF THE DRAWINGS

In the accompanying drawings:

FIG. 1 is a diagram illustrating a schematic configuration of a tire failure determination system according to one embodiment of the present disclosure;

FIG. 2 is a block diagram depicting the configuration of a server illustrated in FIG. 1;

FIG. 3 is a sequence diagram presenting the operation of the tire failure determination system illustrated in FIG. 1;

FIG. 4 is a diagram indicating an example of a thermal image obtained by imaging a tire; and

FIG. 5 is a graph demonstrating changes in the temperature of a damaged portion of a tire according to the inner cavity temperature of the tire.

Hereinafter, a tire failure determination system according to an embodiment of the present disclosure will be described with reference to the drawings. In each drawing, the same reference numerals are assigned to common members and parts. However, it should be noted that the drawings are schematic, and the ratios of the respective dimensions may differ from those in reality.

### Configuration of Tire Failure Determination System

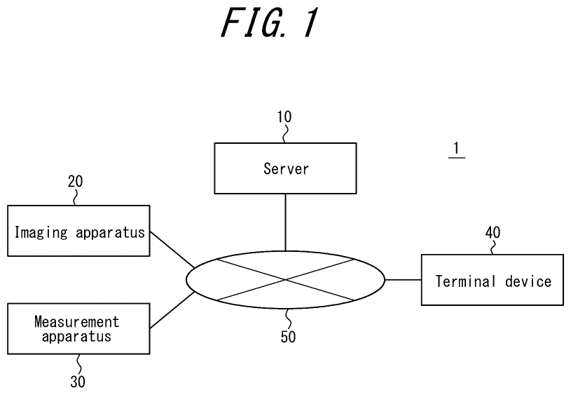

First, with reference to FIG. 1, an overview of the tire failure determination system 1 according to the present embodiment will be described. FIG. 1 is a diagram illustrating a schematic configuration of the tire failure determination system 1. As illustrated in FIG. 1, the tire failure determination system 1 includes a server 10, an imaging apparatus 20, a measurement apparatus 30, and a terminal device 40. In FIG. 1, one server 10, one imaging apparatus 20, one measurement apparatus 30, and one terminal device 40 are depicted, respectively. However, the tire failure determination system 1 may include any number of servers 10, imaging apparatuses 20, measurement apparatuses 30, and terminal devices 40.

The server 10 is constituted by one or more computers. In the present embodiment, the server 10 will be described as being constituted by a single computer. However, the server 10 may be constituted by a plurality of computers, such as a cloud computing system. In the present disclosure, the server 10 is also referred to as a “tire failure determination apparatus.”

The imaging apparatus 20 is constituted by a computer including one or more cameras. The imaging apparatus 20 is, for example, provided with a thermographic camera capable of capturing thermal images. However, the imaging apparatus 20 is not limited to a thermographic camera and may be provided with any camera capable of capturing images, such as a visible light camera or an infrared camera. The images captured by the imaging apparatus 20 may be still images such as photographs, or may be moving images. The imaging apparatus 20 generates a thermal image of the tire 2 and transmits it to the server 10. In the present embodiment, the thermal image of the tire 2 captured by the imaging apparatus 20 includes at least a part of the tire 2. Note that, in addition to at least a part of the tire 2, the thermal image of the tire 2 may also include at least a part of the vehicle 3 on which the tire 2 is mounted.

The imaging apparatus 20 may be, for example, a fixed imaging apparatus 20 installed along the travel route of the vehicle 3 at a mine site. Thus, the imaging apparatus 20 can capture the vehicle 3 traveling along the travel route, making it less likely to reduce the operation rate of the vehicle 3 and the productivity at the mine. However, the imaging apparatus 20 is not limited to a fixed imaging apparatus 20 and may be a mobile imaging apparatus 20, such as an imaging apparatus 20 mounted on a drone or a tablet terminal that can be carried by a person.

The measurement apparatus 30 is constituted by a computer including one or more sensors. The sensors may be, for example, a digital tachograph, a tire pressure monitoring system (TPMS: Tire Pressure Monitoring System), an ECU (Electronic Control Unit), or a car navigation device, but are not limited thereto. The measurement apparatus 30 acquires time-series data related to the tire 2 mounted on the vehicle 3 and transmits it to the server 10. Therefore, the measurement apparatus 30 may be installed on the vehicle 3 or the tire 2.

The time-series data related to the tire 2 mounted on the vehicle 3 includes measurement values related to the tire 2 and the measurement date and time, etc. For example, when the measurement apparatus 30 includes a TPMS installed on the tire 2, the measurement values related to the tire 2 may include tire state information of the tire 2, such as the internal pressure (air pressure) of the tire 2, the inner cavity temperature, or the thermal history. The thermal history of the tire 2 is a history of heat applied to the tire 2 accompanying the use of the tire 2. The thermal history of the tire 2 is used to evaluate how much energy has been applied to the tire 2 since the start of use. Generally, the greater the thermal history, the more the tire 2 deteriorates. The thermal history may be calculated, for example, by applying the inner cavity temperature of the tire 2 to the Arrhenius equation. Also, for example, when the measurement apparatus 30 includes a digital tachograph installed on the vehicle 3, the measurement values related to the tire 2 may include travel information of the vehicle 3, such as travel time, travel distance, speed, acceleration, or the number of rotations of the tire 2.

The terminal device 40 is a computer, such as a smartphone, tablet terminal, or personal computer.

The network 50 is any communication network that allows the server 10, imaging apparatus 20, measurement apparatus 30, and terminal device 40 to communicate with each other. In the present embodiment, the network 50 may be, for example, the Internet, a mobile communication network, a LAN (Local Area Network), or a combination thereof.

The tire failure determination system 1 is used to determine the failure of one or more tires 2. In the tire failure determination system 1, the server 10, for example, acquires a thermal image of the tire 2 captured by a thermographic camera from the imaging apparatus 20. Then, the server 10 acquires the inner cavity temperature of the tire 2 from the measurement apparatus 30. The server 10 estimates the depth of a damaged portion of the tire based on the surface temperature of the damaged portion in the thermal image and the inner cavity temperature at the time the thermal image was captured. In this way, according to the tire failure determination system 1, by using the inner cavity temperature of the tire 2 in addition to the surface temperature of the damaged portion of the tire 2 in the thermal image, it is possible to estimate the depth of the damaged portion with higher accuracy.

In the present disclosure, the tire 2 is not particularly limited, but may be an OR (Off The Road) tire mounted on a mining vehicle such as a transport vehicle, construction vehicle, work vehicle, or heavy machinery vehicle used at a mine site. However, the tire 2 may be a tire other than an OR tire.

Also, in the present disclosure, the vehicle 3 is, for example, a mining vehicle used at a mine site. However, the vehicle 3 is not limited to the above-described mining vehicle and may be any vehicle capable of mounting the tire 2, such as a transport vehicle, construction vehicle, work vehicle, heavy machinery vehicle, bus, passenger vehicle, motorcycle, bicycle, or airplane.

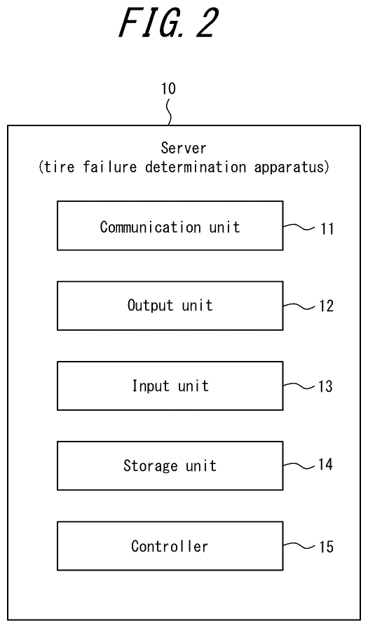

Next, with reference to FIG. 2, the configuration of the server 10, which is a tire failure determination apparatus, will be described in detail. FIG. 2 is a block diagram illustrating the configuration of the server 10. As illustrated in FIG. 2, the server 10 includes a communication unit 11, an output unit 12, an input unit 13, a storage unit 14, and a controller 15. In the server 10, the communication unit 11, output unit 12, input unit 13, storage unit 14, and controller 15 are connected to be able to communicate with each other via wired or wireless connections.

The communication unit 11 includes a communication module for connecting to the network 50. The communication module is, for example, a communication module compatible with mobile communication standards such as 4G (4^{th} Generation) or 5G (5^{th} Generation). The communication module may also be a communication module compatible with standards such as wired LAN or wireless LAN. The communication module may also be a communication module compatible with near field communication standards such as Wi-Fi®, Bluetooth® (Wi-Fi and Bluetooth are each a registered trademark in Japan, other countries, or both), or infrared communication. In the present embodiment, the server 10 is connected to the network 50 via the communication unit 11. As a result, the server 10 can communicate with the imaging apparatus 20, measurement apparatus 30, terminal device 40, or other computers.

The output unit 12 includes one or more output devices. The output devices are, for example, a display, speaker, or lamp. Thus, the output unit 12 outputs images, sound, light, or the like.

The input unit 13 includes one or more input devices. The input devices are, for example, a touch panel, camera, or microphone. The input unit 13, for example, receives input operations from a user of the server 10.

The storage unit 14 is, for example, a semiconductor memory, magnetic memory, or optical memory. The storage unit 14 functions as, for example, a main storage device, auxiliary storage device, or cache memory. The storage unit 14 stores any information used for the operation of the server 10. For example, the storage unit 14 stores a system program, application program, embedded software, or database. The information stored in the storage unit 14 may be updated with information acquired from the network 50 via the communication unit 11.

For example, the storage unit 14 may store tire identification information of one or more tires 2 to be subjected to failure determination. In the present disclosure, the tire identification information is also referred to as a tire ID (Identifier). The tire identification information of the tire 2 is information that can uniquely identify the tire 2. The tire identification information of the tire 2 is, for example, uniquely assigned by the server 10, but is not limited thereto and may be, for example, the manufacturing number of the tire 2 or the vehicle number of the vehicle 3 on which the tire 2 is mounted. Furthermore, the storage unit 14 may store information related to the tire 2 in association with the tire identification information of the tire 2.

The information related to the tire 2 includes any information related to the tire 2. The information related to the tire 2 may include, for example, the above-described time-series data related to the tire 2, damage information of the tire 2, configuration information of the tire 2, information of the vehicle 3 on which the tire 2 is mounted, or position information of the tire 2 mounted on the vehicle 3. The damage information of the tire 2 may include, for example, information such as the position, shape, depth, and registration date and time of damage previously sustained by the tire 2. The configuration information of the tire 2 may include, for example, the type, model number, material properties, tread pattern, belt angle, size, or weight of the tire 2. The information of the vehicle 3 on which the tire 2 is mounted includes identification information, type, model number, displacement, number of mounted tires, or number of shafts of the vehicle 3.

The controller 15 includes one or more processors. The processor may be, for example, a general-purpose processor such as a CPU (Central Processing Unit), or a dedicated processor specialized for specific processing. The controller 15 is not limited to a processor and may include one or more dedicated circuits. The dedicated circuit may be, for example, an FPGA (Field-Programmable Gate Array) or an ASIC (Application Specific Integrated Circuit). The controller 15 controls each component to realize the functions of the server 10, including the functions of the above-described communication unit 11, output unit 12, input unit 13, and storage unit 14.

### Operation of Tire Failure Determination System

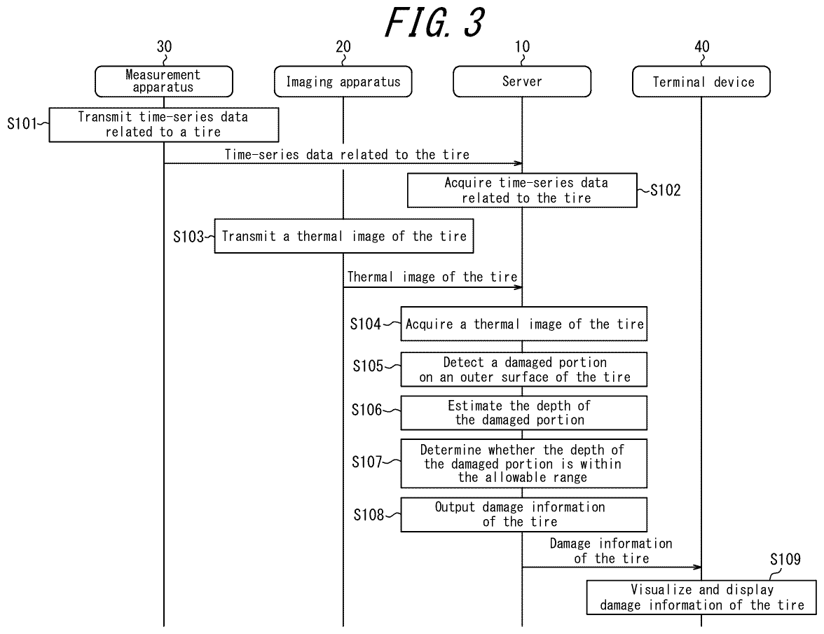

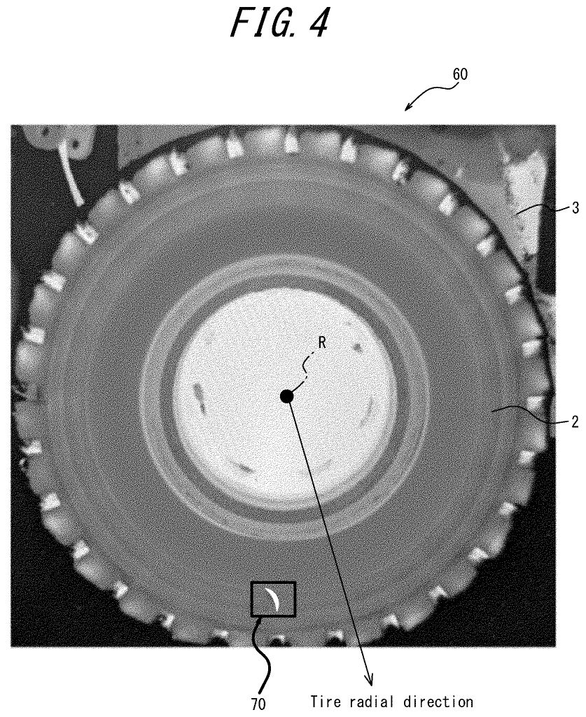

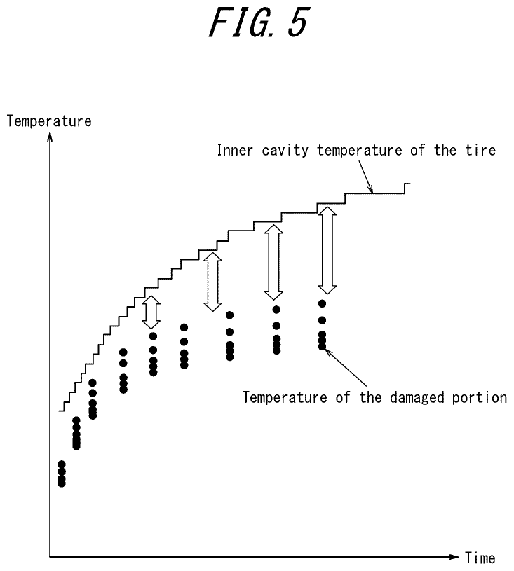

With reference to FIGS. 3, 4, and 5, the operation of the tire failure determination system 1 will be described. FIG. 3 is a sequence diagram illustrating the operation of the tire failure determination system 1. FIG. 4 is a diagram illustrating an example of a thermal image 60 of the tire 2. FIG. 5 is a graph illustrating the change in temperature of a damaged portion 70 of the tire 2 according to the inner cavity temperature of the tire 2. The sequence diagram depicted in FIG. 3 illustrates the operations of the server 10, imaging apparatus 20, measurement apparatus 30, and terminal device 40 included in the tire failure determination system 1. Therefore, the description of this operation corresponds to the tire failure determination method executed by the tire failure determination system 1, as well as the tire failure determination method executed by each of the server 10, imaging apparatus 20, measurement apparatus 30, or terminal device 40 included in the tire failure determination system 1.

In the description of this operation, it is assumed that the controller 15 of the server 10 stores, in the storage unit 14, the tire identification information of the tire 2 and information related to the tire 2 associated with the tire identification information of the tire 2.

Further, in this operation example, as an example, the operation in which the server 10 detects a damaged portion 70 on the outer surface of the side portion of the tire 2 based on the thermal image 60 depicted in FIG. 4 will be described. In such a case, the imaging apparatus 20 may be installed at a position capable of capturing a thermal image 60 of the side surface of the vehicle 3 along the travel route of the vehicle 3 at a mine site.

Referring to FIG. 3, in step S101, the measurement apparatus 30 acquires time-series data related to the tire 2 mounted on the vehicle 3 and transmits it to the server 10.

Specifically, the measurement apparatus 30 acquires time-series data related to the tire 2 at predetermined timings using sensors. The measurement apparatus 30 may transmit the acquired time-series data related to the tire 2 to the server 10 in association with the identification information of the tire 2. For example, the measurement apparatus 30 may transmit the time-series data to the server 10 each time it acquires time-series data related to the tire 2. Alternatively, the measurement apparatus 30 may transmit, in a batch, the time-series data measured during a predetermined period to the server 10. In this operation example, the measurement apparatus 30 is provided with a digital tachograph and a TPMS. Therefore, the time-series data related to the tire 2 may include tire state information of the tire 2, such as the internal pressure (air pressure), inner cavity temperature, and thermal history of the tire 2, as well as travel information of the vehicle 3, such as travel time and travel distance of the vehicle 3. However, the time-series data transmitted from the measurement apparatus 30 is not limited to the above-described information.

In step S102, the controller 15 of the server 10 acquires time-series data related to the tire 2, including the inner cavity temperature of the tire 2.

Specifically, the controller 15 of the server 10 receives the time-series data related to the tire 2 from the measurement apparatus 30 via the communication unit 11. However, the controller 15 may receive the time-series data related to the tire 2 acquired by the measurement apparatus 30 via a computer other than the measurement apparatus 30. The controller 15 may store the received time-series data related to the tire 2 in the storage unit 14 in association with the identification information of the tire 2.

In step S103, the imaging apparatus 20 transmits a thermal image 60 of the tire 2 captured by a thermographic camera to the server 10.

Specifically, the imaging apparatus 20 captures the tire 2 using a thermographic camera and generates a thermal image 60 of the tire 2. In this operation example, as illustrated in FIG. 4, the thermal image 60 is described as a single still image, but it may be a plurality of still images captured continuously or a moving image. The imaging apparatus 20 transmits the captured thermal image 60 to the server 10 together with information on the capture time of the thermal image 60. However, the image transmitted from the imaging apparatus 20 is not limited to the thermal image 60. For example, the imaging apparatus 20 may transmit, together with the thermal image 60, a photograph captured by a visible light camera to the server 10. Further, the thermal image 60 of the tire 2 may include, in addition to at least a part of the tire 2, at least a part of the vehicle 3 on which the tire 2 is mounted. In the thermal image 60 depicted in FIG. 4, a part of the tire 2 and a part of the vehicle 3 on which the tire 2 is mounted are depicted.

Referring again to FIG. 3, in step S104, the controller 15 of the server 10 acquires the thermal image 60 of the tire 2.

Specifically, the controller 15 of the server 10 receives the thermal image 60 of the tire 2 from the imaging apparatus 20 via the communication unit 11, together with information on the capture time of the thermal image 60. However, the controller 15 may receive the thermal image 60 captured by the imaging apparatus 20 via a computer other than the imaging apparatus 20. The controller 15 may store the received thermal image 60 and its capture time in the storage unit 14 in association with the identification information of the tire 2.

Further, in step S104, the controller 15 of the server 10 may identify the identification information of the tire 2 depicted in the thermal image 60 from the thermal image 60. Thus, even if the tire 2 depicted in the thermal image 60 has not been previously identified, the controller 15 can identify the tire 2 from the thermal image 60. Specifically, the controller 15 extracts a display portion indicating the identification information of the tire 2 in the thermal image 60 by image processing. The display portion may be, for example, a two-dimensional code such as a QR (Quick Response) code® (QR code is a registered trademark in Japan, other countries, or both) affixed to the tire 2 or the vehicle 3. In such a case, the controller 15 can read the identification information of the tire 2 from the display portion, which is a two-dimensional code. However, the display portion is not limited to a two-dimensional code and may be any display information such as a character string, symbol, figure, color, pattern, or one-dimensional code.

The display portion indicating the identification information of the tire 2 may be displayed at any position. For example, the display portion may be provided on the outer surface of the tire 2, such as the side portion of the tire 2. In such a case, even if the tire 2 is re-mounted from one vehicle 3 to another vehicle 3 due to tire rotation or the like, the identification information of the tire 2 can continue to be identified based on the same display portion. However, the display portion may be provided on the body of the vehicle 3 on which the tire 2 is mounted. In such a case, by providing the display portion on the body of the vehicle 3, even if the outer surface of the tire 2 becomes dirty with mud or is damaged, the visibility of the display portion is less likely to decrease. In this operation example, the controller 15 of the server 10 is described as identifying the identification information of the tire 2 depicted in the thermal image 60 from the thermal image 60, but this is not limiting. For example, when a photograph captured by a visible light camera is received together with the thermal image 60 from the imaging apparatus 20, the controller 15 may identify the identification information of the tire 2 from this photograph.

In step S105, the controller 15 of the server 10 detects a damaged portion 70 on the outer surface of the tire 2 depicted in the thermal image 60.

Any method may be adopted for detecting the damaged portion 70. For example, the controller 15 of the server 10 may store in advance, in the storage unit 14, an image analysis algorithm for identifying the damaged portion 70 of the tire 2 depicted in the thermal image 60.

Specifically, the controller 15 of the server 10 uses an image analysis algorithm to detect, on the outer surface of the tire 2 depicted in the thermal image 60, a portion whose temperature is higher than that of the surrounding area by at least a threshold temperature, as a damaged portion 70 such as a cut or crack. Generally, as the vehicle 3 travels, the inner cavity temperature of the tire 2 rises. The damaged portion 70 on the outer surface of the tire 2 is closer to the inner cavity of the tire 2 than other portions, and therefore its surface temperature becomes higher. For this reason, the thermal image 60 can be used to detect the position and depth of the damaged portion 70 on the outer surface of the tire 2. By using the thermal image 60, even in cases where the captured outer surface of the tire 2 is dirty, or when the tire 2 is photographed at night, and the detection accuracy of damage in photographs taken with a visible light camera decreases, the detection accuracy of damage is less likely to decrease. In this operational example, in the thermal image 60 depicted in FIG. 4, the controller 15 is described as detecting, as the damaged portion 70, a portion whose temperature is higher than that of the surrounding area. However, the controller 15 may detect all of a plurality of damaged portions 70 if multiple damaged portions 70 exist on the tire 2. The controller 15 may store, in the storage unit 14, information such as the position and number of the detected damaged portions 70 as damage information of the tire 2, in association with identification information of the tire 2. In the thermal image 60 depicted in FIG. 4, the detected damaged portions 70 are highlighted by being enclosed in square frames, but this is not limiting.

The threshold temperature used for detecting the damaged portion 70 may, for example, be a fixed value. The threshold temperature may be determined using an outlier derived by a statistical method such as the 30 method. In such a case, the controller 15 of the server 10 can detect, on the outer surface of the tire 2 depicted in the thermal image 60, a portion whose temperature is higher than that of the surrounding area by at least the threshold temperature, as the damaged portion 70. However, the threshold temperature is not limited to a fixed value, and may be changed by the controller 15 according to the inner cavity temperature of the tire 2 (or a thermal history calculated from the inner cavity temperature) at the time when the thermal image 60 was captured. For this purpose, the controller 15 may store, in advance, in the storage unit 14, information associating the threshold temperature with the inner cavity temperature of the tire 2. Referring now to FIG. 5, the temperatures (surface temperatures) of a plurality of damaged portions 70 at different positions and depths in the tire 2 are illustrated as changing in accordance with changes in the inner cavity temperature of the tire 2. In FIG. 5, the temperatures of the plurality of damaged portions 70 are indicated by dots, and the inner cavity temperature of the tire 2 is indicated by a line. As depicted in FIG. 5, the temperature of the damaged portion 70 of the tire 2 changes according to the inner cavity temperature of the tire 2. Therefore, by changing the threshold temperature used for detecting the damaged portion 70 according to the inner cavity temperature of the tire 2, the detection accuracy of the damaged portion 70 can be improved.

Specifically, as indicated by the arrows in FIG. 5, the inner cavity temperature of the tire 2 and the temperature of the damaged portion 70 exhibit nonlinear behavior over time. In the illustrated example, as time passes and the inner cavity temperature of the tire 2 increases, the deviation between the inner cavity temperature and the temperature of the damaged portion 70 becomes larger. Therefore, the threshold temperature may be set so that the amount of increase in the threshold temperature becomes smaller as the inner cavity temperature of the tire 2 increases. This further improves the detection accuracy of the damaged portion 70 of the tire 2. In the present disclosure, the inner cavity temperature of the tire 2 “at the time when the thermal image 60 was captured” may be the inner cavity temperature of the tire 2 at the time of imaging of the thermal image 60 or at a time point closest to the imaging time in time-series data, or may be a plurality of inner cavity temperatures of the tire 2 during a predetermined period (for example, the one hour immediately before the imaging time) based on the imaging time of the thermal image 60. The plurality of inner cavity temperatures of the tire 2 during the predetermined period may be all time-series data of the inner cavity temperature measured within the predetermined period, or may be data from which outliers have been removed from the time-series data.

In the present embodiment, the image analysis algorithm and the threshold temperature calculation algorithm may be constructed by statistical methods such as machine learning or deep learning. For example, these algorithms may be constructed by statistical methods using, as training data, the thermal image 60 capturing the tire 2 and the damaged portion 70 in the tire 2 identified by a human or the like. In this way, by accumulating training data, the detection accuracy of the damaged portion 70 on the outer surface of the tire 2 can be improved. However, the image analysis algorithm and the calculation algorithm may include predetermined arithmetic processing not based on statistical methods.

Referring again to FIG. 3, in step S106, the controller 15 of the server 10 estimates the depth of the damaged portion 70 on the outer surface of the tire 2 depicted in the thermal image 60.

Any method may be employed for estimating the depth of the damaged portion 70. For example, the controller 15 of the server 10 may estimate the depth of the damaged portion 70 from the surface temperature of the damaged portion 70 of the tire 2 detected in step S105. The controller 15 may store, in advance, in the storage unit 14, a depth estimation algorithm for estimating the depth of the damaged portion 70 from the surface temperature of the damaged portion 70 on the outer surface of the tire 2. The controller 15 uses the depth estimation algorithm to estimate the depth of the damaged portion 70 from the surface temperature of the damaged portion 70. The depth of the damaged portion 70 may, for example, correspond to the depth at the portion of the damaged portion 70 of the tire 2 having the highest surface temperature.

In this case, in addition to the surface temperature of the damaged portion 70 of the tire 2 in the thermal image 60, the controller 15 of the server 10 may estimate the depth of the damaged portion 70 using the inner cavity temperature of the tire 2 included in the time-series data acquired from the measurement apparatus 30. More specifically, in estimating the depth of the damaged portion 70 depicted in the thermal image 60, the depth of the damaged portion 70 is corrected so as to be a different value according to the inner cavity temperature at the time when the thermal image 60 was captured. That is, estimating the depth of the damaged portion 70 in step S106 includes correcting the depth of the damaged portion 70 according to the inner cavity temperature at the time when the thermal image 60 was captured. As depicted in FIG. 5, the surface temperature of the damaged portion 70 of the tire 2 changes under the influence of the inner cavity temperature of the tire 2. Therefore, by correcting the surface temperature of the damaged portion 70 using the relative relationship with the inner cavity temperature of the tire 2, the accuracy of estimating the depth of the damaged portion 70 can be improved.

As described above, in order to correct the depth of the damaged portion 70 estimated from the surface temperature of the damaged portion 70 on the outer surface of the tire 2 by the inner cavity temperature of the tire 2, the controller 15 of the server 10 may store, in advance, in the storage unit 14, information associating the surface temperature and depth of the damaged portion 70 with the inner cavity temperature of the tire 2. In the example depicted in FIG. 5, as indicated by the arrows, as the travel of the vehicle 3 progresses and the inner cavity temperature of the tire 2 increases, the deviation between the temperature of the damaged portion 70 and the inner cavity temperature of the tire 2 becomes larger. Therefore, in estimating the depth of the damaged portion 70, the controller 15 may correct the depth of the damaged portion 70 so that the correction amount of the depth of the damaged portion 70 becomes larger as the inner cavity temperature of the tire 2 at the time when the thermal image 60 was captured becomes higher. In this way, by correcting using the relative relationship between the surface temperature of the damaged portion 70 and the inner cavity temperature of the tire 2, the accuracy of estimating the depth of the damaged portion 70 can be improved.

In the present embodiment, the depth estimation algorithm may be constructed by statistical methods such as machine learning or deep learning. For example, the depth estimation algorithm may be constructed by statistical methods using, as training data, features of the damaged portion 70 of the tire 2 and the depth of the damaged portion 70 measured by a human or the like. In this way, by accumulating training data, the accuracy of estimating the depth of the damaged portion 70 of the tire 2 can be improved. However, the depth estimation algorithm may include predetermined arithmetic processing not based on statistical methods.

Furthermore, estimating the depth of the damaged portion 70 in step S106 may include correcting the depth of the damaged portion 70 according to the position of the damaged portion 70 in the tire 2. The position of the damaged portion 70 in the tire 2 may, for example, as depicted in FIG. 4, be represented by the distance from the rotation axis R of the tire 2 in the tire radial direction. Here, the “tire radial direction” refers to the direction perpendicular to the rotation axis R of the tire. Even for damaged portions 70 of the same depth, the temperature (surface temperature) of the damaged portion 70 may differ depending on the position of the damaged portion 70 in the tire 2. For example, if a turn-up portion of the carcass ply of the tire 2 is present on the inner cavity side of the damaged portion 70, the surface temperature of the damaged portion 70 becomes higher than when it is not present. This is because the heat of the inner cavity of the tire 2 is absorbed by the turn-up portion of the carcass ply and is more easily transmitted to the damaged portion 70. Thus, for example, due to differences in the internal structure such as the thickness of the rubber at the damaged portion 70, the presence or absence of the carcass ply, or differences in the physical properties of components located on the inner cavity side of the damaged portion 70 such as thermal conductivity, the manner in which the inner cavity temperature of the tire 2 is transmitted to the surface of the damaged portion 70 differs. Therefore, by taking into account the different structural features inside the tire 2 according to the distance from the rotation axis R of the tire 2 in the tire radial direction, the accuracy of estimating the depth of the damaged portion 70 can be further improved.

The controller 15 may store, in the storage unit 14, the estimated depth of the damaged portion 70 as damage information of the tire 2, in association with identification information of the tire 2. In addition, when a plurality of damaged portions 70 are detected in the tire 2 depicted in the thermal image 60, the controller 15 may estimate the depth of each of the plurality of damaged portions 70 in this step.

Referring again to FIG. 3, in step S107, the controller 15 of the server 10 determines whether the depth of the damaged portion 70 of the tire 2 is within an allowable range of durability of the tire 2.

In the determination in step S107, the allowable range of durability of the tire 2 may be arbitrarily set. For example, the allowable range of durability of the tire 2 may be defined as a range of the depth of the damaged portion 70 of the tire 2. The controller 15 of the server 10 can, for example, determine that the depth of the damaged portion 70 of the tire 2 is outside the allowable range of durability of the tire 2 when the depth of the damaged portion 70 is deeper than the value defined as the allowable range of durability of the tire 2. In this way, the controller 15 of the server 10 can automatically determine, based on the depth of the damaged portion 70 of the tire 2, whether the tire 2 is within the allowable range of durability. When a plurality of damaged portions 70 are detected in the tire 2 depicted in the thermal image 60, the controller 15 may make this determination based on the damaged portion 70 estimated to be the deepest among the plurality of damaged portions 70, or may make this determination based on the total value or average value of the depths of the plurality of damaged portions 70.

Furthermore, when a plurality of damaged portions 70 are detected in the tire 2 depicted in the thermal image 60, the controller 15 of the server 10 may determine whether the depths of the plurality of damaged portions 70 are within the allowable range based on the relative depths of the plurality of damaged portions 70. Specifically, if the depth of any of the plurality of damaged portions 70 detected in the tire 2 is relatively deeper than the other damaged portions 70, it is considered that the progression of that damaged portion 70 is faster. Therefore, when a damaged portion 70 whose relative depth is deeper than the other damaged portions 70 exists in the tire 2, the allowable range may be set so that the depth of the damaged portion 70 is more likely to exceed the allowable range. For example, the controller 15 may change the range of the depth of the damaged portion 70 of the tire 2 defined as the allowable range of durability of the tire 2 according to the average value or standard deviation of the depths of the plurality of damaged portions 70. In this way, the accuracy of determining whether the tire 2 is within the allowable range of durability based on the depth of the damaged portion 70 of the tire 2 can be further improved.

Alternatively, the controller 15 of the server 10 may change the range of the depth of the damaged portion 70 of the tire 2 defined as the allowable range of durability of the tire 2 according to the position of the damaged portion 70 in the tire 2. As described above, the position of the damaged portion 70 in the tire 2 may, for example, be represented by the distance from the rotation axis R of the tire 2 in the tire radial direction. For example, the durability of that portion also differs according to the internal structure such as the thickness of the rubber at the damaged portion 70 and the presence or absence of the carcass ply. Therefore, by taking into account the different structural features inside the tire 2 according to the distance from the rotation axis R of the tire 2 in the tire radial direction, the accuracy of determining whether the tire 2 is within the allowable range of durability can be further improved.

Furthermore, in the determination in step S107, the allowable range of durability of the tire 2 may be defined in a composite manner using, in addition to the depth of the damaged portion 70 of the tire 2, other elements. The other elements are, for example, information included in the time-series data relating to the tire 2 acquired from the measurement apparatus 30. As one example, the controller 15 of the server 10 may determine whether the depth of the damaged portion 70 is within the allowable range of durability of the tire 2 based on the depth of the damaged portion 70 and the travel distance or travel time of the vehicle 3 on which the tire 2 is mounted. Specifically, if the depth of the damaged portion 70 of the tire 2 is deep despite the travel distance or travel time of the vehicle 3 being short, it is considered that the progression of that damaged portion 70 is fast. Therefore, the allowable range may be set so that the depth of the damaged portion 70 is more likely to fall outside the allowable range as the depth of the damaged portion 70 of the tire 2 is deeper and the travel distance or travel time of the vehicle 3 on which the tire 2 is mounted is shorter. In this way, the accuracy of determining whether the tire 2 is within the allowable range of durability based on the depth of the damaged portion 70 of the tire 2 can be further improved.

As another example, the controller 15 of the server 10 may determine whether the depth of the damaged portion 70 is outside the allowable range of durability of the tire 2 based on the depth of the damaged portion 70 of the tire 2 and the thermal history of the tire 2. Specifically, if the thermal history of the tire 2 is large, it is considered that the tire 2 has already deteriorated and the progression of the damaged portion 70 of the tire 2 is fast. Therefore, the allowable range may be set so that the depth of the damaged portion 70 is more likely to exceed the allowable range as the depth of the damaged portion 70 of the tire 2 is deeper and the thermal history of the tire 2 is larger. In this way, the accuracy of determining whether the damaged portion 70 of the tire 2 exceeds the allowable range of durability of the tire 2 can be improved.

The allowable range of durability of the tire 2 may be set in multiple stages. For example, the allowable range of durability of the tire 2 may be set in stages, such as a level at which the tire 2 needs to be replaced immediately, a level at which the tire 2 needs to be replaced within one month, a level at which the tire 2 needs to be replaced within two months, and so on. In this way, the tire failure determination system 1 can perform different processing, such as transmitting different warning messages, according to the stage of the allowable range of durability.

In step S108, when it is determined that the damaged portion 70 of the tire 2 is outside the allowable range, the controller 15 of the server 10 outputs damage information of the tire 2 including the position, number, or depth of the damaged portion 70.

Any method may be employed for outputting the damage information of the tire 2. For example, the controller 15 of the server 10 may display the damage information of the tire 2 via the output unit 12 such as a display. Alternatively, the controller 15 may transmit, via the communication unit 11, a request to display the damage information of the tire 2 to the terminal device 40. In such a case, the terminal device 40, in step S109, can display the damage information of the tire 2 via a display or the like based on the request received from the server 10. The damage information of the tire 2 includes, for example, the depth of the damaged portion 70 of the tire 2. However, the damage information of the tire 2 is not limited to the depth of the damaged portion 70 of the tire 2, and may include any information such as the position, number, or warning message regarding the damaged portion 70. As a result, a user of the tire failure determination system 1 can easily grasp the degree of depth of the damaged portion 70 on the outer surface of the tire 2, and can plan inspection, repair, replacement, or the like of the tire 2 before the tire 2 fails. In particular, when the tire 2 is to be replaced, the tire 2 may be replaced with a different tire 2 according to the damage information of the tire 2. For example, if the surface temperature of the damaged portion 70 is higher than the durable temperature set for the tire 2, the tire 2 may be replaced with another type of tire 2 having higher heat resistance. Alternatively, if the number of damaged portions 70 exceeds a predetermined number, the tire 2 may be replaced with another type of tire 2 that is less likely to develop damaged portions 70. In this way, the user of the tire failure determination system 1 can select a tire 2 suitable for use at a mine site based on the damage information of the tire 2.

As described above, in the present embodiment, the server 10, which is a tire failure determination apparatus, acquires a thermal image 60 obtained by imaging the tire 2 with a thermographic camera, and also acquires the inner cavity temperature of the tire 2. The server 10 estimates the depth of the damaged portion 70 based on the surface temperature of the damaged portion 70 in the thermal image 60 and the inner cavity temperature at the time the thermal image 60 was captured.

According to such a configuration, the server 10 can estimate the depth of the damaged portion 70 with higher accuracy by using not only the surface temperature of the damaged portion 70 in the thermal image 60 but also the inner cavity temperature of the tire 2. Therefore, according to the present embodiment, it is possible to improve the usefulness of the technology for determining tire failure.

In the above operational example, the operation of detecting the damaged portion 70 on the outer surface of the side portion of the tire 2 in the tire failure determination system 1 has been described, but the present disclosure is not limited thereto. The outer surface of the tire 2 to be processed by the tire failure determination system 1 may include at least one of the outer surface of the side portion or the outer surface of the tread portion of the tire 2. That is, the tire failure determination system 1 may be used to detect the damaged portion 70 on the outer surface of the tread portion of the tire 2 in addition to or instead of the side portion of the tire 2. In such a case, the imaging device 20 may be installed at a position where the front or rear of the vehicle 3 can be imaged in order to image the tread portion of the tire 2. Then, as in the above operational example, the server 10 acquires a thermal image 60 obtained by imaging the tread portion of the tire 2 with the imaging device 20, and also acquires the inner cavity temperature of the tire 2. The server 10 then estimates the depth of the damaged portion 70 based on the surface temperature of the damaged portion 70 in the thermal image 60 and the inner cavity temperature at the time the thermal image 60 was captured. Thus, the server 10 can determine the depth of the damaged portion 70 on the outer surface of the tread portion of the tire 2 in addition to or instead of the side portion of the tire 2.

The present disclosure has been described based on the drawings and embodiments, but it should be noted that various modifications and alterations can be made based on the present disclosure by those skilled in the art. Therefore, it should be noted that such modifications and alterations are included within the scope of the present disclosure. For example, the configurations or functions included in each embodiment can be rearranged so as not to be logically inconsistent. In addition, the configurations or functions included in each embodiment can be used in combination with other embodiments, and it is possible to combine a plurality of configurations or functions into one, divide them, or omit a part thereof.

Further, for example, an embodiment in which a general-purpose computer functions as the server 10 according to the above-described embodiment is also possible. Specifically, a program describing the processing contents for realizing each function of the server 10 according to the above-described embodiment is stored in the memory of a general-purpose computer, and the processor reads and executes the program. Therefore, the present disclosure can also be realized as a program executable by a processor or as a non-transitory computer-readable medium storing the program. Examples of non-transitory computer-readable media include, for example, magnetic storage devices, optical disks, magneto-optical recording media, or semiconductor memories.

### INDUSTRIAL APPLICABILITY

According to the present disclosure, it is possible to provide a tire failure determination method and a tire failure determination apparatus that can improve the usefulness of the technology for determining tire failure.

### REFERENCE SIGNS LIST

1: tire failure determination system, 2: tire, 3: vehicle, 10: server (tire failure determination apparatus), 11: communication unit, 12: output unit, 13: input unit, 14: storage unit, 15: controller, 20: imaging device, 30: measurement apparatus, 40: terminal device, 50: network, 60: thermal image, 70: damaged portion, R: rotation axis

1. A tire failure determination method to be executed by a computer, the tire failure determination method comprising:
acquiring a thermal image obtained by imaging a tire with a thermographic camera;
acquiring an inner cavity temperature of the tire; and
estimating a depth of a damaged portion of the tire based on a surface temperature of the damaged portion in the thermal image and the inner cavity temperature at a time when the thermal image was captured.

2. The tire failure determination method according to claim 1, further comprising detecting, as the damaged portion, a portion on an outer surface of the tire appearing in the thermal image, the portion being higher than surrounding portions by a threshold temperature or more,
wherein the threshold temperature is changed according to the inner cavity temperature at the time when the thermal image was captured.

3. The tire failure determination method according to claim 1, wherein the estimating of the depth of the damaged portion includes correcting the depth of the damaged portion according to the inner cavity temperature at the time when the thermal image was captured.

4. The tire failure determination method according to claim 3, wherein the estimating of the depth of the damaged portion includes correcting the depth of the damaged portion so that a correction amount of the depth of the damaged portion increases as the inner cavity temperature at the time when the thermal image was captured is higher.

5. The tire failure determination method according to claim 1, wherein the estimating of the depth of the damaged portion includes correcting the depth of the damaged portion according to a position of the damaged portion in the tire.

6. The tire failure determination method according to claim 1, further comprising determining whether the depth of the damaged portion is within an allowable range of durability of the tire.

7. The tire failure determination method according to claim 6, wherein the determining includes, in a case in which a plurality of damaged portions is detected in the tire, determining whether depths of the plurality of damaged portions are within the allowable range based on relative depths of the plurality of damaged portions.

8. The tire failure determination method according to claim 6, further comprising acquiring a travel distance or travel time of a vehicle on which the tire is mounted,
wherein the determining includes determining whether the depth of the damaged portion is within the allowable range based on the depth of the damaged portion and the travel distance or travel time of the vehicle, and
wherein the allowable range is set so that the depth of the damaged portion is more likely to fall outside the allowable range as the depth of the damaged portion is deeper and the travel distance or travel time of the vehicle is shorter.

9. A tire failure determination apparatus comprising:
a controller configured to
acquire a thermal image obtained by imaging a tire with a thermographic camera;
acquire an inner cavity temperature of the tire; and
estimate a depth of a damaged portion of the tire based on a surface temperature of the damaged portion in the thermal image and the inner cavity temperature at a time when the thermal image was captured.

10. The tire failure determination method according to claim 2, wherein the estimating of the depth of the damaged portion includes correcting the depth of the damaged portion according to the inner cavity temperature at the time when the thermal image was captured.

11. The tire failure determination method according to claim 10, wherein the estimating of the depth of the damaged portion includes correcting the depth of the damaged portion so that a correction amount of the depth of the damaged portion increases as the inner cavity temperature at the time when the thermal image was captured is higher.

12. The tire failure determination method according to claim 2, wherein the estimating of the depth of the damaged portion includes correcting the depth of the damaged portion according to a position of the damaged portion in the tire.

13. The tire failure determination method according to claim 2, further comprising determining whether the depth of the damaged portion is within an allowable range of durability of the tire.

14. The tire failure determination method according to claim 13, wherein the determining includes, in a case in which a plurality of damaged portions is detected in the tire, determining whether depths of the plurality of damaged portions are within the allowable range based on relative depths of the plurality of damaged portions.

15. The tire failure determination method according to claim 13, further comprising acquiring a travel distance or travel time of a vehicle on which the tire is mounted,
wherein the determining includes determining whether the depth of the damaged portion is within the allowable range based on the depth of the damaged portion and the travel distance or travel time of the vehicle, and
wherein the allowable range is set so that the depth of the damaged portion is more likely to fall outside the allowable range as the depth of the damaged portion is deeper and the travel distance or travel time of the vehicle is shorter.
